(19) United States
(12) Patent Application Publication
(10) Pub. No.: US 2010/0102563 A1
(43) Pub. Date: Apr. 29, 2010

(54) DEVICE FOR WAVE-POWERED GENERATOR

(75) Inventor: Olaf Akervoll, Messines (PT)

Correspondence Address: MAIER & MAIER, PLLC, 1000 DUKE STREET, ALEXANDRIA, VA, 22314, US

(73) Assignee: Methanpetrol Lda, Messines (PT)

(21) Appl. No.: 12/528,697

(22) PCT Filed: Mar. 6, 2008
(86) PCT No.: PCT/NO08/00082

§ 371 Date: Aug. 26, 2009

(30) Foreign Application Priority Data
Mar. 13, 2007 (NO) 20071356

(51) Int. Cl. F03B 13/18

(52) U.S. Cl. 290/53

(57) ABSTRACT

Device for a wave-powered generator where a generator via a drive and a primary drive line is connected to a float arranged floating on a water surface, and the drive comprises: a first and a second drive shaft each provided with a freewheel and a drive roller; a part of the primary drive line in engagement with each of the drive rollers; the inlet direction of the primary drive line on the first drive roller being opposite to the inlet direction on the second drive roller such that a linear movement of the drive line rotates the first drive roller opposite to the second drive roller; and the freewheels are interconnected by means of a transmission means effecting the freewheels outgoing rotational motions being identical; and one of the freewheels via further transmission means is arranged to be able to rotate the generator's drive shaft.

### RELATED APPLICATIONS

The present invention claims priority under 35 U.S.C. §119 to Norwegian Patent Application No. NO 20071356, filed on Mar. 13, 2007, the disclosure of which is incorporated by reference herein in its entirety.

### BACKGROUND

The invention relates to a drive device for transforming a linear movement induced by a wave motion on a water surface to a unidirectional, rotating motion, more particularly a device for transmission of floats movements on a water surface to a rotating movement of a power generator.

In the following description the terms “wave-power station” and “generator” are partly used for devices arranged to produce electric power. It is within the scope of the invention that the “wave-power station” and the “generator” just as well can produce other forms of power, such as that of a pump delivering pressurized liquid. The terms “wave-power station” and “generator” is therefore to be understood in a wider sense, i.e. related to electric power, than these terms have in the everyday language.

Many different systems for utilization of wave and tidal power for the production of energy, such as electric power, are known. The problems within this area have been that the technical equipment has not stood up to the large loads that the waves inflict on a wave-power station, and the efficiency has been too low. To avoid breakdown, the wave-power station has been tried moved to areas of “quieter” sea and weather conditions. This has naturally led to worse utilization of the wave power and lower efficiency.

The aim of the invention is to remedy or reduce at least one of the prior art drawbacks.

The aim is achieved by features described in the description below and in the following claims.

To achieve maximum utilization of a wave and tidal power station, it is necessary to position the equipment in areas exposed to storms and powerful waves. It is an aim of the invention to obtain a wave power station where just one of its main elements, a float arrangement, is positioned in the wave influenced area, while the rest of the wave power station, a main module comprising among other things a drive device and generator, is positioned submerged under the sea surface and at a depth where the waves do not essentially propagate, possibly on land, as the floats and the main module are tension-wise connected by a drive line, preferably a chain or at least a combination of chain and wire and/or rod for transfer of wave motion from the floats to the main module.

The invention relates particularly to a device for an as far as possible direct and efficient transfer of the power created in a wave motion on the sea surface, to the main module drive and generator. This is achieved by having a load, such as a load weight, connected via the tension-wise drive line to the first float, as this load will provide for the drive line being held taut and being pulled back when the float moves down from a wave crest. The drive line is led via a first and second drive shaft in the main module, and where the drive line, at least that part being in contact with drive rolls provided on the drive shafts, is made up of a chain meshing with chain tracks on the drive roll circumferences. The drive rolls are in the form of chain wheels with a track dimension adapted to the chain. Utilization of chains and chain wheels gives a contact area between driving and driven means which is insensitive to fouling, the chain wheels thus providing no slippage occur when drive line tension pulls the drive shafts around. Alternatively a form of sprocket chain can be used, such as a roller chain and corresponding sprocket wheels.

The two drive shafts have freewheels arranged such that they grip in the same direction. Because the drive line envelops the one drive roll in the opposite direction to the envelopment direction on the other drive roll, the linear motion of the drive line will result in the drive shafts rotating in opposite directions. In addition the freewheels are connected together in such a way that the driving freewheel rotates the other freewheel in the same direction. The cooperation of the mutually opposite directions of rotation for the drive shafts and the interconnection of the freewheels results in the one drive shaft transmitting rotational movement to the generator when the first float is lifted by a wave, while the other drive shaft transmits rotational movement to the generator when the first float moves down into a wave trough. The two freewheels are both connected to a generator provided on the main module, via transmission means.

The invention also relates to a second float, which is connected to said drive line via a secondary drive line and means for change of direction for the secondary drive line with the least possible friction. The second float has a distance from the first float adapted to the wavelength and the wave frequency in such a way that when the first float is on a wave crest, the second wave is in a wave trough. Thus the two floats will be able to cooperate for best possible power transmission to the generator. The device includes means for registering wavelength and wave frequency, process the registered data and automatically control the distance between the two floats to achieve the desired cooperative float motion.

The invention relates in a first aspect more particularly to a device for a wave-power station comprising a main module provided with at least one generator which via a drive and a primary drive line is connected to a first float arranged floating on a water surface, characterized in that the drive comprises:

a first drive shaft provided with a first freewheel and a first drive roller;

a second drive shaft provided with a second freewheel and a second drive roller;

a part of the primary drive line in engagement with both drive rolls;

as the primary drive line direction of entry on the first drive roller is the opposite of the direction of entry on the second drive roller to thereby effect that a linear motion of the drive line in a certain direction effects the first drive shaft to rotate in a first direction and the second drive shaft to rotate in a second direction opposite to the first direction; and
the first freewheel and the second freewheel are interconnected by a transmission means effecting the outgoing rotational motion of the freewheels to be equal; and
one of the freewheels via further transmission means is arranged to be able to rotate the generator drive shaft.

Preferably the first and the second drive rollers are chain wheels, and the part of the primary drive line in engagement with each of the drive rollers, is a chain.

Advantageously ballast provided to maintain tension in the primary drive line over the drive rollers and at the downward movement of the first float to rotate the drive, is connected to the primary drive line.

Advantageously the main module is positioned submerged in water and preferably positioned floating over a seabed as it is provided with buoyancy elements and anchoring means fastened to the seabed.

Alternatively the main module is positioned on land.

In a second aspect of the invention a second float provided floating on the sea surface, is connected to the primary drive line via a secondary drive line and positioned at a distance from the first float.

The distance between the first and the second float corresponds preferably essentially with the wave frequency and wavelength such that when the first float is on a wave crest, then the second float is in a wave trough.

A device for automatic control of the distances between the first and the second float comprises advantageously positioning guides for the first and the second drive line, means for registering the motion speed and direction of the first drive line, means for calculating desired distance between the first and second float and a device provided to control the distance between the positioning guides.

### BRIEF DESCRIPTION OF THE DRAWINGS

In the following is described a non-limiting example of a preferred embodiment illustrated in the accompanying drawings, where:

FIG. 1 shows a principle drawing of a wave power station of the invention;

FIGS. 2a and 2b show side views of the drive rollers and freewheels respectively, with connected transmission means for transfer of rotational motion to an inlet shaft on a generator; and

FIG. 3 shows a wave power station where the main module is positioned on land.

### DETAILED DESCRIPTION

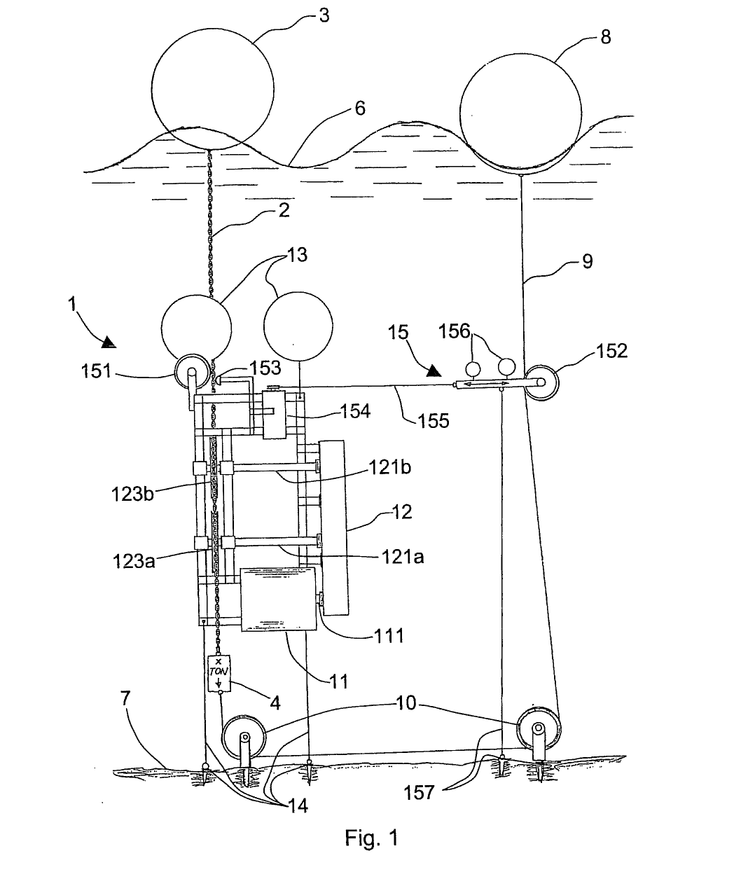

Referring first to FIG. 1, a wave power station is in its entirety positioned in water, as a main module 1 comprising a generator 11, a drive 12 and buoyancy elements 13 are fastened to a seabed 7 by anchoring means 14. Buoyancy elements 13 and anchoring means 14 keep the main module in a submerged state at a distance from a water surface 6.

A first float 3 is connected to a drive line 2 led over two drive rollers 123a, 123b providing a part of the drive 12.

The primary drive line 2 is at a lower part fastened to a ballast 4 in the shape of a weight positioned at a distance to the seabed 7.

The wave power station also comprises per se known means for speed control (not shown) of the generator 11 and means (not shown) for transfer of power from the generator 11 to a consumer, for example via a distribution network for electric power in case the generator 11 is an electric generator.

The wave power station according to the invention is adapted to function in the configuration described above, but by providing the wave power station with a second float 8 with an appurtenant secondary drive line 9, a coordinated wave induced movement of the floats 3, 8 gives an improved utilization of the wave power.

The second float 8 is connected to a first end part of the secondary drive line 9 which via sheaves 10 anchored to the seabed are led to the ballast 4 where the secondary drive line 9 is connected to the primary drive line 2. A device 15 for controlling the distance between the first and the second float 3, 8 comprises a first positioning guide 151 in the shape of a sheave fixed to the main module 1 in the immediate vicinity of the inlet of the primary drive line 2 to the one drive roller 123b, plus a second positioning guide 152 positioned horizontally movable at a distance from the main module 1. The device 15 comprises buoyancy elements 156 and anchoring means 157, which attend to the second positioning guide 152 being kept floating submerged at about the same depth as the first positioning guide 151. The second positioning guide 152 is connected to the main module 1 via an actuator 154 connected to an essentially vertically positioned stay. The actuator 154 is connected to a sensor 153 provided for registering the direction and speed of movement in the primary drive line 2. The actuator 154 is equipped with a control unit (not shown), which based on signals from the sensor 153, is arranged to control the actuator 154 movement of the stay 155 by the actuator 154 engagement with the stay 155.

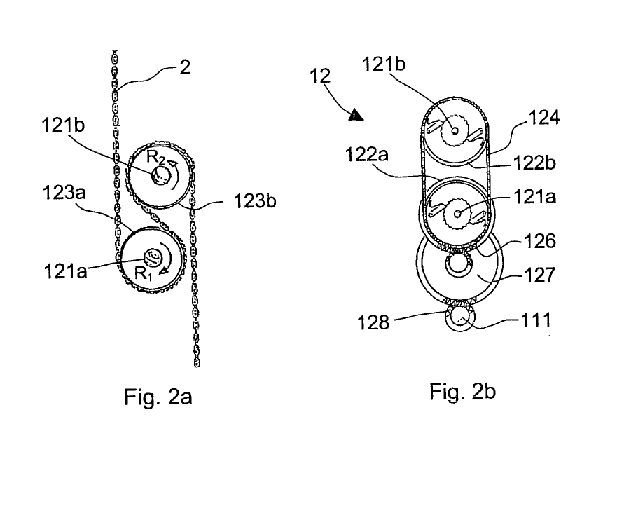

Referring to FIGS. 2a and 2b, parts of the drive are shown in greater detail.

The primary drive line 2 is engaged to a first and a second drive roller 123a, 123b arranged in a first end part of drive shafts 121a and 121b respectively. A second end part of the drive shafts 121a, 121b is equipped with a freewheel 122a, 122b each, which are interconnected with a drive chain 124 in engagement with a corresponding toothed circumference on the freewheels 122a, 122b. The first freewheel 122a is arranged to be in driving engagement with a direction of rotation R₁, while the other freewheel 122b is arranged to be in driving engagement with a direction of rotation R₂ equal to the direction of rotation R_{I}. The first freewheel 122a is also equipped with a toothed circumferential part 126 drivingly engaged to a first gear 127 for transferring the first free-wheel 122a rotational movement to the generator 11 drive shaft 111 via a second gear 128 fixed on the generator 11 drive shaft 111.

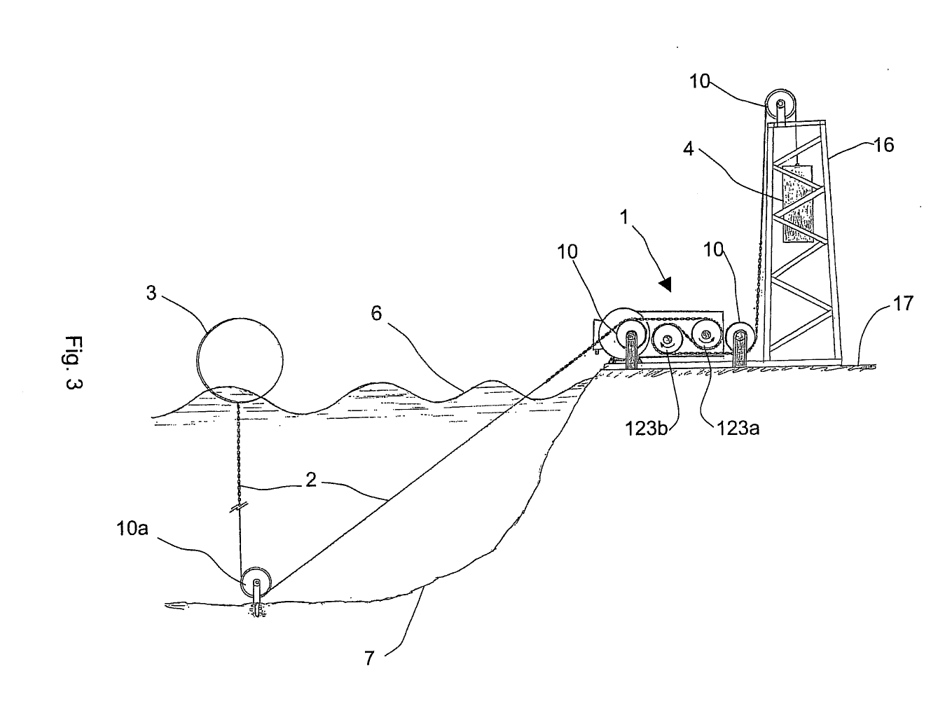

FIG. 3 shows an exemplary embodiment where the main module 1 is placed on land 17, as the drive line 2 via sheaves 10, 10a and the main module's 1 drive rollers 123a, 123b is led to the ballast 4 here positioned hanging in a tower 16. This exemplary embodiment is in other respects arranged as described for corresponding elements above.

When a wave motion in the water surface 6 sets the first float 3 in motion upwards towards a wave crest, does this lead to a vertical upwards linear movement of the drive line 2. This gives the drive shafts 121a, 121b a rotary motion as the first drive shaft 121a, due to the different envelopment directions of the drive line 2 on the two drive rollers 123a, 123b, is rotated in the direction R₁, while the other drive shaft 121b is rotated in the direction R₂ which is opposite to R₁. Dependent on the design-wise chosen working direction for the generator 11 drive shaft 111 and the configuration of the drive 12, a certain driving direction of rotation for the freewheels 122a, 122b is chosen. One of the two freewheels will, at the upward motion of the drive line, transfer the respective drive shaft 121a or 121b rotation movement directly or via the drive chain 124 to the gears 127, 128 and to the generator 11.

When the first float 3 moves from a wave crest towards a wave trough, the downward linear motion of the drive line 2 will change the direction of rotation of the drive shafts 121a, 121b. The changed direction of rotation leads to the transfer of the rotating motion changing to the other of the two freewheels 122a, 122b, which transfer the rotating motion via the drive chain 124 or directly to gears 127, 128 and to the generator 11.

At the first float's 3 motion downwards from the wave crest, the ballast 4 provides a tension in the drive line 2 of a magnitude sufficient to rotate the generator 11.

By utilizing the configuration with a second float 8 tied to the primary drive line, the device 15 for controlling the distance between the first and second floats will, by registering motion speed and direction of the primary drive line 2 and calculation of the wave frequency, lead to the distance between the first and second floats 3, 8 being adjusted to position the second float in a wave phase opposite to the wave phase wherein the first float is. Thus the second float 8 will cooperate with the first float 3 to keep a more uniform linear tension in the primary drive line 2 so that the power production in the generator is increased.

By arranging the main module 1 as shown in FIG. 3, some design and operational problems caused by water, especially seawater, are reduced or eliminated.

For a person skilled in the art it will obvious to combine a wave power station having floats 3, 8 in anti-phase with a main module 1 placed on land 17.

What is claimed is:

1. Device for a wave-powered generator comprising:
a main module provided with at least one generator which via a drive and a primary drive line is connected to a first float arranged floating on a water surface, wherein the drive further comprises:
a first drive shaft provided with a first freewheel and a first drive roller;
a second drive shaft provided with a second freewheel and a second drive roller;
a part of the primary drive line in engagement with each of the drive rollers;
the direction of entry of the primary drive line on the first drive roller being opposite to the direction of entry on the second drive roller, thereby effecting a linear drive line movement in a certain direction to effect the first drive roller rotate in a first direction and the second drive roller rotate in a second direction; and
the first freewheel and the second freewheel are interconnected by means of a transmission means effecting the outgoing rotational motion of the freewheels being identical; and
one of the freewheels via further transmission means is arranged to be able to rotate the generator's drive shaft, wherein the first and the second drive rollers are chain wheels, and the part of the primary drive line in engagement with each of the drive rollers is a chain, or are sprocket wheels, and the part of the primary drive line in engagement with each of the drive rollers is a roller chain, wherein, when the main module is floatingly above the sea floor, the primary drive line is attached to a ballast arranged to maintain tension in the primary drive line over the drive rollers and by the first float's downward movement to rotate the drive, and the main module is provided with buoyancy elements and anchoring means fixed to the seabed.

2. Device in accordance with claim 1, wherein the generator is an electrical generator or a pump.

3. Device in accordance with claim 1, wherein in that a second float, arranged floating on the water surface, is connected to the primary drive line via secondary drive line and is positioned at a distance from the first float.

4. Device in accordance with claim 1, characterized in that a device for controlling the distance between the first and the second float comprises positioning guides for the primary and secondary drive lines means for registering speed and direction of movement of the first drive line, means for calculating desired distance between the first and second floats and a device arranged to control the distance between the positioning guides.

5. Device in accordance with claim 1, wherein the distance between the first and the second float essentially corresponds to wave frequency and wavelength such that when the first float is on a wave crest, then the second float is in a wave trough.
